(19) United States
(12) Patent Application Publication
(10) Pub. No.: US 2018/0003110 A1
(43) Pub. Date: Jan. 4, 2018

(54) Acoustically-Enhanced Separators for Aircraft Engines

(71) Applicant: FloDesign Sonics, Inc., Wilbraham, MA (US)

(72) Inventors: Bart Lipkens, Hampden, MA (US); Walter M. Presz, JR., Wilbraham, MA (US); Wayne A. Thresher, Springfield, MA (US); Brian Kennedy, Wilbraham, MA (US); Thomas J. Kennedy, III, Wilbraham, MA (US)

(21) Appl. No.: 15/641,166

(22) Filed: Jul. 3, 2017

Related U.S. Application Data
(60) Provisional application No. 62/357,418, filed on Jul. 1, 2016.

(51) Int. Cl. F02C 7/055; B64D 33/02; B64D 27/10; B64D 27/16

(52) U.S. Cl. CPC F02C 7/055; B64D 33/02; B64D 2033/0246; B64D 27/10; B64D 27/16; B64D 2033/0273

(57) ABSTRACT

Engine inlets are disclosed that include an intake opening for the ingress of incoming air and acoustic filtration means for generating an acoustic wave that separates or clarifies material from the incoming air. The acoustic filtration means can include at least one ultrasonic transducer with a piezoelectric material configured to be driven to create an acoustic wave, such as a multi-dimensional acoustic wave or angled acoustic wave. Physical filtration means, such as an inertial or vortical separator, can be provided. Other engine inlets are also disclosed in which the acoustic filtration means are located within the physical filtration means. Further disclosed are methods for separating material from air employing acoustic separation means and physical filtration means.

### CROSS-REFERENCE TO RELATED APPLICATIONS

This application claims priority to U.S. Provisional Patent Application Ser. No. 62/357,418, filed on Jul. 1, 2016, the disclosure of which is hereby fully incorporated herein by reference in its entirety.

### BACKGROUND

They are many different types of filters and separators that are utilized for the separation and filtration of particles that would normally be ingested into the intake of a jet or gas turbine engine.

The goal of these filters and separators is to remove or direct away particles of dirt and dust that would be deleterious to both the aspiration of the engine and the erosion and destruction of exposed parts in the engine.

Vortical and inertial separators achieve some success in the removal of large particles, but fail to remove finer dust particles that may damage and choke an air aspirating engine. Physical filters are able to remove most of the particles that would normally be ingested into an air aspirating engine, but suffer from being clogged during use and eventually shutting off the air flow into the air aspirating engine.

It would therefore be desirable to remove both small and large particles from air prior to intake into an air aspirating engine, such as a jet or gas turbine engine, without causing diminished airflow or damage from small particles into the air aspirated engine.

### BRIEF SUMMARY

The present disclosure provides methods and devices that utilize acoustics to assist separators (e.g., vortical and inertial separators) with the separation of fine particles that would normally be ingested into a gas turbine or jet engine, such as the engine of an aircraft (e.g., a helicopter or a small airplane). The methods and devices of the present disclosure can also be used in a filter “train” including a physical filter, such that the load on the physical filter is reduced and air flow is improved over time.

Disclosed in example embodiments herein are aircraft engines. In a first example embodiment, an engine inlet comprises an intake opening for the ingress of incoming air; and acoustic filtration means for generating an acoustic wave that separates or clarifies material from the incoming air.

In certain embodiments, the acoustic filtration means can be located downstream of the intake opening.

The first example engine inlet can further comprise physical filtration means for physically separating the material from the incoming air. In certain embodiments, the physical filtration means can include a vortical separator. In particular embodiments, the at least one vortical separator can include a plurality of vortical separators arranged in series. The at least one vortical separator and the acoustic filtration means can be arranged in series with the at least one vortical separator located between the intake opening and the acoustic filtration means. The at least one vortical separator can further be located upstream of the acoustic filtration means. In other embodiments, the physical filtration means can include a barrier filter that collects particles from the incoming air. In particular embodiments, the engine inlet can further comprise an intake manifold located about an inner wall of the engine inlet between the acoustic filtration means and the physical filtration means, the intake manifold configured to receive the material that is physically separated from the incoming air by the physical filtration means.

Further yet, the first example engine inlet can comprise an intake appendage, wherein the acoustic filtration means is located upstream of the intake opening between the intake opening and the inlet appendage.

In a second example embodiment, an engine inlet comprises physical filtration means for physically separating material from incoming air; and acoustic filtration means for generating an acoustic wave configured to separate or clarify material from incoming air, the acoustic filtration means located within the physical filtration means.

The physical filtration means can be an inertial separator including an air intake that splits into first and second flow streams, the first flow stream leading to a waste exit and the second flow stream leading to a clarified air outlet. The acoustic filtration means can be disposed in both of the first and second flow streams.

In a third example embodiment, an engine inlet comprises an intake opening for the ingress of incoming air; and a vortical separator including blades configured to vibrate at a frequency that generates an acoustic wave that urges the material to an inner wall of the engine inlet.

Further disclosed herein is a method for separating material from air. In an example embodiment, the method comprises receiving incoming air via an intake opening of an engine inlet; and employing acoustic separation means to generate an acoustic wave that separates or clarifies material from the incoming air. In certain embodiments, the method can further comprise employing physical filtration means to physically separate the material from the incoming air

In each example embodiment, the acoustic filtration means can include at least one ultrasonic transducer including a piezoelectric material that is configured to be driven to create an acoustic wave in the engine inlet. The at least one ultrasonic transducer can be configured to be driven to create a multi-dimensional acoustic wave. The at least one ultrasonic transducer can also be configured to be driven to create an angled acoustic wave oriented at an acute angle relative to the direction of mean flow through the engine inlet. In particular embodiments, the at least one ultrasonic transducer can include a plurality of ultrasonic transducers disposed about an inner wall of the engine inlet.

In other embodiments, the acoustic filtration means can include a moving rotor configured to rotate relative to a stationary rotor to create a pulsed acoustic wave.

The example engine inlets can be part of the engine for an aircraft (e.g., a helicopter).

These and other non-limiting characteristics are more particularly described below.

### BRIEF DESCRIPTION OF THE DRAWINGS

The following is a brief description of the drawings, which are presented for the purposes of illustrating the example embodiments disclosed herein and not for the purposes of limiting the same.

FIG. 1 is a cross-sectional illustration of an example engine inlet for an air aspirating engine utilizing dual vortical separators and a plurality of ultrasonic transducers.

FIG. 2 is a cross-sectional illustration of an inertial separator incorporating acoustic filtration means.

FIG. 3 is a cross-sectional illustration of an example engine inlet for an air aspirating engine utilizing a vortical separator and a pair of rotors for acoustic filtration.

FIG. 4 is a cross-sectional illustration of an example engine inlet for an air aspirating engine utilizing a vortical separator and acoustic filtration means disposed between an inlet appendage and the vortical separator.

FIG. 5 is a cross-sectional illustration of an example engine inlet for an air aspirating engine utilizing a vortical separator having blades configured to vibrate at a frequency that generates an acoustic wave that urges the material to an inner wall of the engine inlet.

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function. Furthermore, it should be understood that the drawings are not to scale.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named components/steps and permit the presence of other components/steps. However, such description should be construed as also describing compositions or processes as “consisting of” and “consisting essentially of” the enumerated components/steps, which allows the presence of only the named components/steps, along with any impurities that might result therefrom, and excludes other components/steps.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

A value modified by a term or terms, such as “about” and “substantially,” may not be limited to the precise value specified. The approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.”

It should be noted that some of the terms used herein may be relative terms. For example, the terms “upper” and “lower” are relative to each other in location, e.g. an upper component is located at a higher elevation than a lower component in a given orientation, but these terms can change if the device is flipped. The terms “inlet” and “outlet” are relative to a fluid flowing through them with respect to a given structure, e.g. a fluid flows through the inlet into the structure and flows through the outlet out of the structure. The terms “upstream” and “downstream” are relative to the direction in which a fluid flows through various components, e.g. the fluid flows through an upstream component prior to flowing through the downstream component. It should be noted that in a loop, a first component can be described as being both upstream of and downstream of a second component.

The terms “horizontal” and “vertical” are used to indicate direction relative to an absolute reference, e.g. ground level. The terms “upwards” and “downwards” are also relative to an absolute reference; an upwards flow is always against the gravity of the earth.

The present application may refer to “the same order of magnitude.” Two numbers are of the same order of magnitude if the quotient of the larger number divided by the smaller number is a value of at least 1 and less than 10.

The acoustophoretic technology of the present disclosure employs acoustic standing waves to concentrate and/or separate fine particles. As material (e.g., fine particles) flow past or through the acoustic standing wave(s), the acoustic standing wave(s) traps (retains or holds) the material (e.g., secondary phase materials, including fluids and/or particles). The scattering of the acoustic field off the material results in a three-dimensional acoustic radiation force, which acts as a three-dimensional trapping field.

As the particles are trapped, they can begin to coalesce, clump, aggregate, and/or agglomerate, and grow into larger particle clusters. These particle clusters can be subsequently affected by inertial and/or vortical separation and ejected from the airstream before the airstream reaches the gas turbine or jet engine.

The acoustic wave may also be utilized to push particles out of the main air flow, especially smaller particles that do not respond as well to separation by the vortical separator. An angled acoustic standing wave may also be utilized to aid in pushing fine materials to the edge of the intake so that such material can be pushed out of the main flow. The angled acoustic wave may be an acoustic standing wave where the “push” and “pull” of the material in the angled wave acts to separate the material from the main incoming air.

In particular embodiments, it may be desirable that the ultrasonic transducer(s) generate a three-dimensional or multi-dimensional acoustic standing wave in the fluid that exerts a lateral force on the suspended particles to accompany the axial force so as to increase the particle trapping capabilities of the standing wave. A planar or one-dimensional acoustic standing wave may provide acoustic forces in the axial or wave propagation direction. The lateral force in planar or one-dimensional acoustic wave generation may be two orders of magnitude smaller than the axial force. The multi-dimensional acoustic standing wave may provide a lateral force that is significantly greater than that of the planar acoustic standing wave. For example, the lateral force may be of the same order of magnitude as the axial force in the multi-dimensional acoustic standing wave. The three-dimensional acoustic radiation force generated in conjunction with an ultrasonic standing wave is referred to in the present disclosure as a three-dimensional or multi-dimensional standing wave.

For three-dimensional acoustic fields, Gor'kov's formulation can be used to calculate the acoustic radiation force Fac applicable to any sound field. The primary acoustic radiation force Fac is defined as a function of a field potential U,

F_{A}=−∇(U)

where the field potential U is defined as

$$U = {V}_{0} [ \frac{〈 {p}^{2} 〉}{2 {ρ}_{f} {c}_{f}^{ 2}} {f}_{1} - \frac{3 {ρ}_{f} 〈 {μ}^{2} 〉}{4} {f}_{2} ]$$

and f₁ and f₂ are the monopole and dipole contributions defined by

$${f}_{1} = 1 - \frac{1}{{Λσ}^{2}}$$

$${f}_{2} = \frac{2 ( Λ - 1 )}{2 Λ + 1}$$

where p is the acoustic pressure, u is the fluid particle velocity, Λ is the ratio of particle density ρₚ to fluid density ρ_{f}, σ is the ratio of sound speed cₚ through the particle to fluid sound speed c_{f}, V₀ is the volume of the particle, and < > indicates time averaging over the period of the wave.

The contrast factor of the particles and secondary fluids is based on the density and speed of sound (compressibility) properties of the particles and secondary fluid.

Gor'kov gives the time-averaged force on a single, small, compressible sphere in an arbitrary sound field as:

$$F = - ∇ ( \frac{2}{3} π {R}^{3} [ \frac{\overline{{P}^{2}}}{{ρ}_{f} {c}_{f}^{ 2}} - \frac{\overline{{P}^{2}}}{{ρ}_{p} {c}_{p}^{ 2}} \frac{3 {ρ}_{f} ( {ρ}_{p} - {ρ}_{f} )}{2 {ρ}_{p} - {ρ}_{f}} \overline{{v}^{2}} ] )$$

where P̅²̅ is the temporal mean square of the acoustic pressure, ν̅²̅ is the temporal mean square of the fluid displacement velocity, and R is the particle radius.

The pressure and the acoustic displacement velocity are spatially dependent, such that the above equation can be rewritten for a one-dimensional longitudinal wave in the x-direction as:

$$F = - \frac{2}{3} π {R}^{3} \times ( [ \frac{1}{{ρ}_{f} {c}_{f}^{ 2}} - \frac{1}{{ρ}_{p} {c}_{p}^{ 2}} ] \frac{\partial \overline{{P}^{2}}}{\partial x} - [ \frac{3 {ρ}_{f} ( {ρ}_{p} - {ρ}_{f} )}{2 {ρ}_{p} - {ρ}_{f}} ] \frac{\partial \overline{{v}^{2}}}{\partial x} )$$

Using the equation for adiabatic gases that states

$$P = - {ρ}_{f} {c}_{f}^{ 2} \frac{\partial ξ}{\partial x}$$

where P denotes the pressure fluctuations and ξ is the displacement of a fluid particle from its equilibrium position, and given a standing wave of the form:

P(x,t)=A cos(ωt−kx)+A cos(ωt+kx)

where P(x,t) denotes the pressure at any given point in space and time along a single dimension x, ω is the angular frequency of the wave, the amplitude of the standing wave is given by 2×A (A denoting pressure amplitude), and k is the wave number, which is equal to ω/c_{f}, it can be shown that:

$$v ( x , t ) = \frac{A}{{ρ}_{f} {c}_{f}} cos ( ω t - kx ) + \frac{A}{{ρ}_{f} {c}_{f}} cos ( ω t + kx )$$

where v(x,t) denotes the acoustic displacement velocity at any given point in space and time along a single dimension x.

The spatial gradient of the temporal average of the square of acoustic pressure P

$$\frac{\partial \overline{{P}^{2}}}{\partial x} = - 2 {A}^{2} k sin ( 2 kx )$$

and similarly for the temporal average of the square of the fluid displacement velocity:

$$\frac{\partial \overline{{Pv}^{2}}}{\partial x} = \frac{2 {A}^{2} k}{{ρ}_{f}^{ 2} {c}_{f}^{ 2}} sin ( 2 kx )$$

thus, Gor'kov's equation can be reduced to:

F=A²ωC sin(2kx)

where

$$C = - \frac{4}{3} π {R}^{3} \frac{- 5 {ρ}_{p}^{2} {c}_{p}^{ 2} + 2 {ρ}_{p} {c}_{p}^{ 2} {ρ}_{f} + 2 {ρ}_{f} {c}_{f}^{ 2} {ρ}_{p} + {ρ}_{f}^{ 2} {c}_{f}^{ 2}}{{c}_{f}^{ 3} {ρ}_{f} {c}_{p}^{ 2} {ρ}_{p} ( 2 {ρ}_{p} + {ρ}_{f} )}$$

Thus, the displacement for a particle is given.

The use of sound waves may be utilized in a transient (one way) wave that emanates from a speaker and moves a particle in the direction of the propagating wave. Particles may also be trapped in an angled acoustic wave and moved in a direction through the combination of sound energy and fluid dynamics. An acoustic standing wave may also be utilized to agglomerate particles that can be subsequently separated by a secondary means, such as a vortical or inertial separator. An agent, such as microspheres or a secondary fluid may also be added to the inlet to aid in the acoustic separation of fine particles, which may be on the order of from about 1×10⁻⁶ meters to about 1×10⁻³ meters, for example.

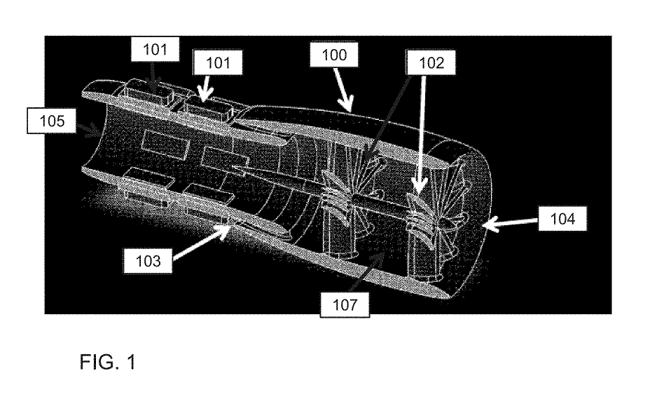

The technology of the present disclosure can be used in an air aspirating engine of an aircraft (e.g., a helicopter). For example, FIG. 1 illustrates a first example configuration for an air intake of an engine inlet 100. For purposes of brevity, the first example engine inlet 100 will be described in full detail and any like parts found in the other embodiments will not be described again and will be referred to using like numbers. The first example engine inlet 100 has an intake opening 104 at a first end of the inlet 100. The intake opening 104 generally permits the ingress of incoming air into the engine inlet 100. At a second end of the inlet opposite the first end thereof an exit 105 is located, which generally permits the egress of outgoing air that has been clarified and/or filtered in the engine inlet 100.

Clarification and/or filtration of air in the engine inlet 100 can be achieved by various means. For example, in the first example embodiment illustrated in FIG. 1, the engine inlet 100 includes both physical filtration means 102 and acoustic filtration means 101.

As can be seen, in this example embodiment, the physical filtration means 102 includes a pair of vortical separators arranged in series near the intake opening 104. The vortical separator(s) generally achieves filtration of particles from air by density separation using centrifugal force. In particular, the physical filtration means 102 generally clarify and/or filter the incoming air of larger material (e.g., large particles, such as dirt) and generates vortices that force this larger material to an inner wall 107 of the inlet 100 (i.e., along an inner periphery of the engine inlet) from which the larger material can be removed via an intake manifold 103 located along the inner wall 107 of the inlet 100. In this way, the intake manifold 103 serves to act as a conduit between the interior of the inlet and a waste stream for removing material filtered by the physical filtration means 102. Although the physical filtration means 102 depicted here are dual vortical separators, it is to be understood that other filtration means can be added to, substituted for, or combined with the vortical separator(s).

Located downstream (i.e., in the direction of air flow from the intake opening 104 to the exit 105) of the physical filtration means 102 and the intake manifold 103 are acoustic separation means 101. As explained herein, the acoustic filtration means 101 further clarify the incoming air by filtering out fine particles by harnessing the power of acoustophoresis. In this way, the acoustic filtration means 101 are generally capable of filtering material that is smaller in size (e.g., finer particles, such as dust) than the physical filtration means 102 and can thus reduce the load on the physicals filtration means 102 and improve air flow over time.

As can be seen, in this example embodiment, the acoustic filtration means 101 includes a plurality of ultrasonic transducers disposed about the engine inlet 100 and coupled thereto (e.g., through inner wall 107). In this way, the acoustic filtration means 101 achieve full or near-full coverage of the engine inlet 100, which further aids in ensuring sufficient clarification and/or filtration of the incoming air. As explained above, the acoustic filtration means 101 can be one or more ultrasonic transducers including a piezoelectric material that is configured to be driven to create an acoustic wave in the engine inlet 100. To achieve efficient trapping of material in the acoustic wave, the transducer(s) can be configured to be driven to create a multi-dimensional acoustic wave (including a three-dimensional acoustic wave).

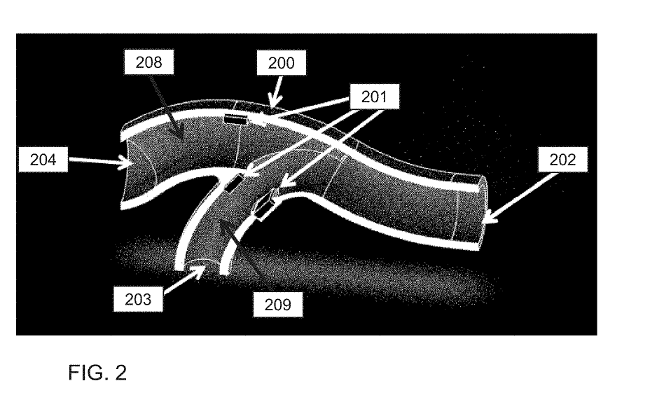

Turning now to FIG. 2, an inertial separator 200 is illustrated that is enhanced with the addition of acoustic filtration means 201. The inertial separator 200 includes an intake 202 at a first end thereof for the ingress of incoming air. The intake 202 splits into a first flow stream 208 and a second flow stream 209. As can be seen in this example embodiment, the acoustic filtration means 201 are located within the inertial separator 200 and are particularly located in both of the first and second flow streams 208, 209. The first flow stream 208 leads to a waste exit 204 from which material (e.g., particles including dirt and dust) filtered out of the incoming air is dispelled. On the other hand, the second flow stream 209 leads to a clarified air outlet that carries air that has been filtered and/or clarified of deleterious material to an associated engine.

The acoustic filtration means 201 can include one or more ultrasonic transducers as described herein. Further, the ultrasonic transducer(s) can be configured to be driven to create an angled acoustic wave oriented at an acute angle relative to the direction of mean flow through the engine inlet. In this way, as seen in FIG. 2, the ultrasonic transducer(s) disposed within the second flow stream 209 can be angled to urge material toward first flow stream 208, such that the separated material is dispelled via the waste exit 204 and does not reach the clarified air outlet 203 or the associated engine. The placement of the acoustic filtration means 201 in the internal separator 200 illustrated in FIG. 2 is chosen such that particle material is urged, via acoustic pressure, away from the clarified air outlet 203 toward waste exit 204. The internal separator 200 illustrated in FIG. 2 can be used as the physical filtration means of the inlet or intake of an air aspirating engine.

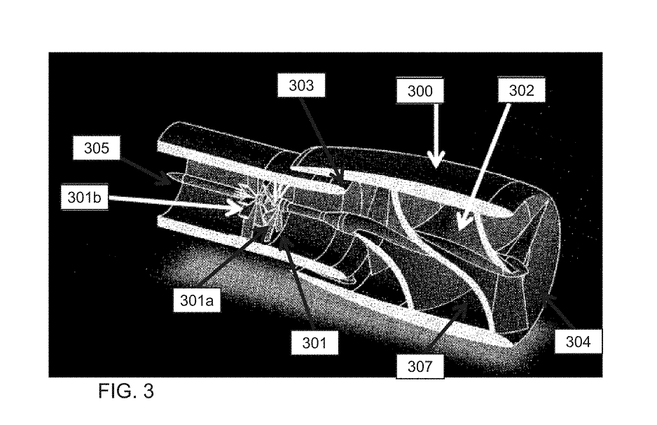

FIG. 3 illustrates another example embodiment of an engine inlet. In FIG. 3, example engine inlet 300 again includes both physical filtration means 302 and acoustic filtration means 301. In this example embodiment, the physical filtration means 302 includes a single vortical separator that creates inertial forces/vortices that urges material to the inner wall 307 of the engine inlet 300 (e.g., along an inner periphery of the engine inlet) toward an intake manifold 303 located along the inner wall 307 of the inlet 300. As previously explained, the intake manifold 303 can therefore act as a conduit between the interior of the inlet and a waste stream for removing material filtered by the physical filtration means 302.

Located downstream of the physical filtration means 302 and the intake manifold 303 is acoustic filtration means 301. In this example embodiment, the acoustic filtration means 301 includes a pair of tandem rotors 301a, 301b, one configured to remain stationary and the other configured to rotate relative to the stationary rotor. In this example, rotor 301a rotates and rotor 301b is stationary, however, in other examples, rotor 301a can be stationary and rotor 301b can rotate. As shown in FIG. 3, the stationary rotor 301b and the moving rotor 301a are located very close to one another, such that when the moving rotor 301a is rotated relative to the stationary rotor 301b, a pulsed sound is created (e.g., by creating a pulsed sound that creates an acoustic wave). The pulsed sound generates an acoustic wave that can be used to urge material in the incoming air out of the main air flow path (namely, material that passed through or that was not filtered out by the physical filtration means 302 via the intake manifold 303). While the moving rotor 301a is depicted upstream of the stationary rotor 301b in this example embodiment, the relative locations of the rotors could be switched as desired. Moving and/or non-moving rotors can be combined in various combinations and/or in multiples to create the pulsed sound.

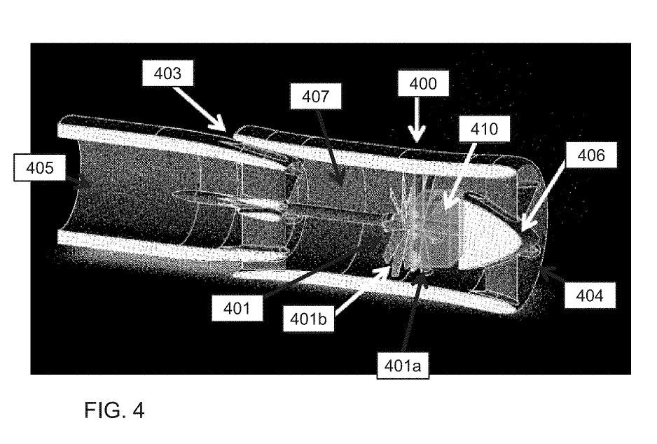

Another example engine inlet 400 is illustrated in FIG. 4. In example engine inlet 400, an acoustic wave 410 is generated between an inlet appendage 406 and acoustic filtration means 401, the acoustic wave 410 acting to trap and agglomerate material (e.g., fine particles, such as dust) that is drawn into the engine inlet 400. In this example embodiment, the acoustic filtration means 401 includes a moving blade 401a configured to rotate relative to a stationary blade 402a to create a pulsed sound that generates the acoustic wave 410. While the moving blade 401a is depicted upstream of the stationary blade 401b in this example embodiment, the relative locations of the rotors could be switched as desired. As further seen here, the inlet appendage 406 is generally disposed at the intake opening 404 of the engine inlet upstream of the acoustic wave 410. The moving blade 401a of the acoustic filtration means 401 also generally acts as a vortical separator and urges material (e.g., large particles, such as dirt) to an inner wall 407 of the engine inlet 400 (i.e., along an inner periphery of the engine inlet) for removal via the intake manifold 403. In particular, the moving blade 401a of the acoustic filtration means 401 acts as a vortical separator by generating vortices that causes the incoming air and material to move in a centrifugal fashion, or to be urged away from a center. The vorticies urge the larger material to the inner wall 407 of the engine inlet 400 toward the intake manifold 403. Further, it is noted that because the acoustic filtration means 401 are located upstream of the intake manifold 403 in this example embodiment, the fine material filtered by the acoustic filtration means 401 can be removed from the engine inlet 400 via the intake manifold 403 before reaching exit 405.

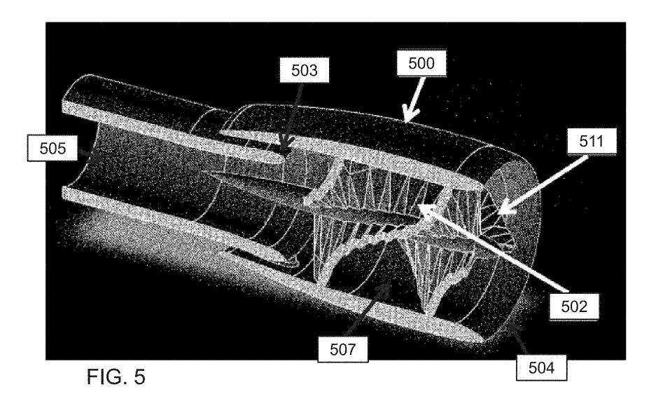

FIG. 5 illustrates yet another example embodiment of an engine inlet. Example engine inlet 500 includes a vortical separator 502 located between intake opening 504 and intake manifold 503. The vortical separator 502 that incorporates thin blades 511 that are configured to vibrate at a frequency that generates an acoustic wave in the engine inlet 500. As explained herein, the acoustic wave urges material that enters the engine inlet 500 to an inner wall 507 of the engine inlet 500 (e.g., along an inner periphery of the engine inlet). An intake manifold 503 is located along the inner wall 507 of the engine inlet 500 and acts as a conduit to a waste stream for removing the filtered material from the engine inlet 500.

Other physical filtration means may be used in conjunction with the acoustic filtration means of the present disclosure to assist in the separation of particles from an air stream. Additional example physical filtration means include high efficiency particulate air (HEPA) filters. These filters can, for example, be constructed from nano-fiber fabrics (e.g., made of carbon nanotube fibers) to provide increased surface and smaller pore size, enabling the capture and separation of finer particles than conventional filters. As explained above, the use of acoustic separation means in conjunction with physical filtration means aids in reducing the load on the physical filtration means, such that air flow is improved over time.

The present disclosure has been described with reference to example embodiments. Modifications and alterations may occur to others upon reading and understanding the preceding detailed description. It is intended that the present disclosure be construed as including all such modifications and alterations insofar as they come within the scope of the appended claims or the equivalents thereof.

1. An engine inlet, comprising:
an intake opening for the ingress of incoming air; and
an acoustic filter for generating an acoustic wave that separates or clarifies material from the incoming air.

2. The engine inlet of claim 1, wherein the acoustic filter is located downstream of the intake opening.

3. The engine inlet of claim 1, wherein the acoustic filter includes at least one ultrasonic transducer including a piezoelectric material that is configured to be driven to create an acoustic wave in the engine inlet.

4. The engine inlet of claim 3, wherein the at least one ultrasonic transducer includes a plurality of ultrasonic transducers disposed about an inner wall of the engine inlet.

5. The engine inlet of claim 1, wherein the acoustic filter includes a moving rotor configured to rotate relative to a stationary rotor to create a pulsed acoustic wave.

6. The engine inlet of claim 1, further comprising a physical filter for physically separating the material from the incoming air.

7. The engine inlet of claim 6, wherein the physical filter includes at least one vortical separator.

8. The engine inlet of claim 7, wherein the at least one vortical separator and the acoustic filter are arranged in series with the at least one vortical separator located between the intake opening and the acoustic filtration means.

9. The engine inlet of claim 8, further comprising an intake manifold located about an inner wall of the engine inlet between the acoustic filter and the physical filter, the intake manifold configured to receive the material that is physically separated from the incoming air by the physical filter.

10. The engine inlet of claim 1, further comprising an intake appendage, wherein the acoustic filter is located upstream of the intake opening between the intake opening and the inlet appendage.

11. An aircraft engine comprising the engine inlet of claim 1.

12. An engine inlet, comprising:
physical filtration means for physically separating material from incoming air; and
acoustic filtration means for generating an acoustic wave configured to separate or clarify material from incoming air, the acoustic filtration means located within the physical filtration means.

13. The engine inlet of claim 12, wherein the physical filtration means is an inertial separator including an air intake that splits into first and second flow streams, the first flow stream leading to a waste exit and the second flow stream leading to a clarified air outlet.

14. The engine inlet of claim 13, wherein the acoustic filtration means are disposed within both of the first and second flow streams.

15. The engine inlet of claim 12, wherein the acoustic filtration means includes at least one ultrasonic transducer including a piezoelectric material that is configured to be driven to create an acoustic wave in the physical filtration means.

16. The engine inlet of claim 12, wherein the at least one ultrasonic transducer is configured to be driven to create a multi-dimensional acoustic wave.

17. The engine inlet of claim 12, wherein the at least one ultrasonic transducer is configured to be driven to create an angled acoustic wave oriented at an acute angle relative to the direction of mean flow through the engine inlet.

18. An aircraft engine comprising the engine inlet of claim 12.

19. A method for separating material from a gaseous fluid, comprising:
receiving incoming gas via an intake opening of an engine inlet; and
employing an acoustic separator to generate an acoustic wave that separates or clarifies material from the incoming air.

20. The method of claim 19, further comprising employing physical filtration means to physically separate the material from the incoming air.
